(19) United States
(12) Patent Application Publication
(10) Pub. No.: US 2015/0206283 A1
(43) Pub. Date: Jul. 23, 2015

(54) FLICKERING PIXEL FOR DISPLAYING HIGH RESOLUTION IMAGES AND VIDEOS

(71) Applicant: Andrei Pavlov, Naantali (FI)

(72) Inventor: Andrei Pavlov, Naantali (FI)

(21) Appl. No.: 14/587,622

(22) Filed: Dec. 31, 2014

Related U.S. Application Data
(60) Provisional application No. 61/922,855, filed on Jan. 1, 2014.

(51) Int. Cl. G06T 3/40

(52) U.S. Cl. CPC G06T 3/4053

(57) ABSTRACT

The system comprises a processor for dividing an image into a series of pixels, grouping a selected numbers of pixels into a pixel group and a circuit for providing power to individual pixels in the pixel group in succession, at a switching rate controlled by the processor, the switching rate being fast enough that an observer sees all pixels in a pixel group being energized at substantially the same time.

### BACKGROUND OF THE INVENTION

The innovation described in this patent specification is related to high-resolution imaging and video technologies. The aim of the innovation is reduction of power consumption by screens, displays of computers and mobile devices, television devices and projectors when displaying high resolution images, films or videos. The power reduction is achieved by special control of electronics devices and, particularly, pixel devices of displays or projectors using the novel algorithm. The algorithm allows using less number of electronics devices simultaneously switched on at the same time to display high quality, HD, images and videos.

### DESCRIPTION OF THE DRAWINGS

FIG. 1 is a diagram showing a flickering pixel consisting of four pixels. A switching sequence is shown where a switched pixel is shown by white color. Corresponding matrix values are shown as well.

FIGS. 2a and 2b are diagrams of an image, square frame, displayed using flickering pixels. FIG. 2a and FIG. 2b show the result of integration of few separate images, the square frame.

FIG. 3 is a diagram of switching algorithm/program. The matrix

$$( \begin{matrix}1 & 0 \\ 0 & 0\end{matrix} )$$

is multiplied by the color matrix

$$( \begin{matrix}a & b \\ c & d\end{matrix} )$$

and then changes its value to the next value

$$( \begin{matrix}0 & 1 \\ 0 & 0\end{matrix} )$$

by arithmetic functions. The operation is repeated so that the pixels are switched one by one. The results of arithmetic operations are shown in insets (a) and (b).

FIG. 4 is a diagram of a 4×4 matrix arranged with 4 flickering pixels. The flickering pixels are working synchronically. A larger matrix can be arranged in a similar way.

FIG. 5 is a diagram of an algorithm/program representing a larger matrix by using the flickering pixels. The two-dimensional matrix has elements indexed along x- and y-axes.

FIG. 6 is a diagram showing video frames using flickering pixels.

FIG. 7 is a diagram representing short-term memory. If two signals come within a short period of time, then these signals can be integrated into one image. The upper portion of FIG. 7 applies. If the second signal comes after a long time, then the first signal is already significantly decayed. The integration is not possible, as shown in the lower portion of FIG. 7.

### DESCRIPTION

The invention is switching architecture for reproducing high-quality images or video frames on a screen, computer display or mobile device. If the image has a resolution m x n and is represented on a screen, in order to show the image in full resolution, m x n pixel devices are needed. Each pixel device is connected to a power source. All pixel devices are switched on all the time. In the present invention, instead of simultaneously switching on all pixels for each image, only a part of the pixels are switched on at a time for a relatively short time, and then after the short period of time, another part of the pixels is switched on while the first part is switched off. The pixels in an image are divided into two or more groups which are periodically switched on and off If the time period between two switching times is very short, the observer has an impression that he or she sees the whole image with high resolution as if all pixels are switched on.

The invention is realized by using a flickering pixels' switching algorithm. Each flickering pixel is a group of a few neighboring pixels. There should be two or more pixels in one flickering pixel. During operation, only one pixel of the flickering pixel is switched on at a time while others are switched off, although more than one can be switched on if the pixel group is three or more.

The whole high-resolution image can be represented by using flickering pixels which are much smaller in number than the total number of pixels of the whole image. For example, if the flickering pixel comprises four pixels, then the total number of flickering pixels is m/2×n/2 or 1/4 the total number of pixels. Accordingly, the power consumption of the screen is reduced by a factor of at least four. Taking into account that the electronics devices will be less heated due to reduced average switching time, additional energy savings can be achieved as well. Hence, batteries of mobile devices can work longer, the screen does not heat as much as in traditional operational mode, and the reliability of such devices will hence be much better.

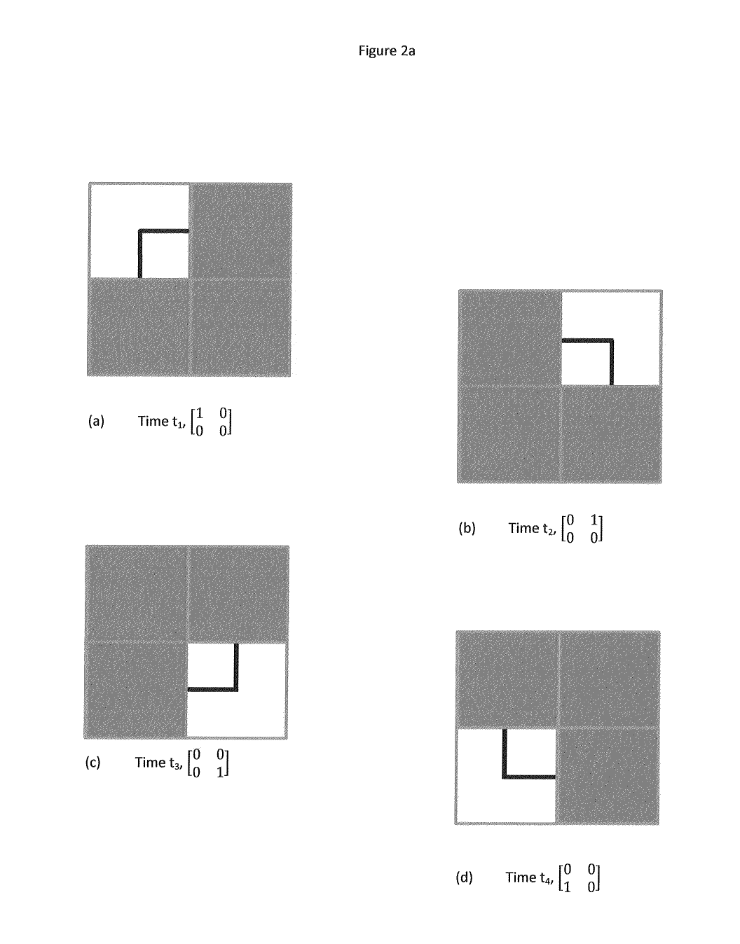

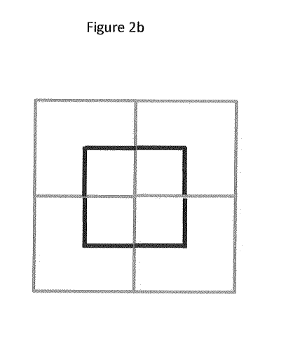

The flickering pixel system operates in the following way. When one or in some cases more than one pixel in each pixel group is switched on, the others are switched off. After a short period of time, another pixel in the group is switched on, the others are switched off, and so on. The operation repeats periodically so that one pixel of each flickering pixel is periodically switched on for a period of time that equals to the integrated switching time in the other pixels of the flickering pixel. If such images are repeated with a relatively high frequency or short periods, then the observer can view a high resolution image as if all pixels are switched on. The impression of full resolution image or picture is a result that human's visual memory is capable to remember the image with high detail, near to full detail, during a specific short time. If the images are displayed one after another in a relatively short periods of time, the short visual memory can integrate the images and construct the integrated complete image. This will give the impression of a high-resolution image. This is directed to visual memory in a broad sense. More specific and precise memory mechanisms could also be used. The time period should be shorter than the time needed for short visual memory to distinguish different images, typically shorter than few milliseconds. So, if the repetition time is short enough, the near-similar images, if they are changed relatively frequently, in few milliseconds or less, will give an integrated picture. These images are integrated by the human eye using the short visual memory and bring a full resolution impression of the m×n image despite the actual number of switched pixels at a time is less, for example, m/2×n/2 if the group consists of 2×2 pixels. Accordingly, less power is used to switch on the smaller number of pixels. In the above example, only one quarter of the power required to switch on all the pixels is used. One group of pixels is called a flickering pixel because only a fraction of the pixel group is switched at a time. FIG. 2 demonstrates the invention where a square frame is shown by integration of parts of the image when the parts are displayed at slightly different times in sequence.

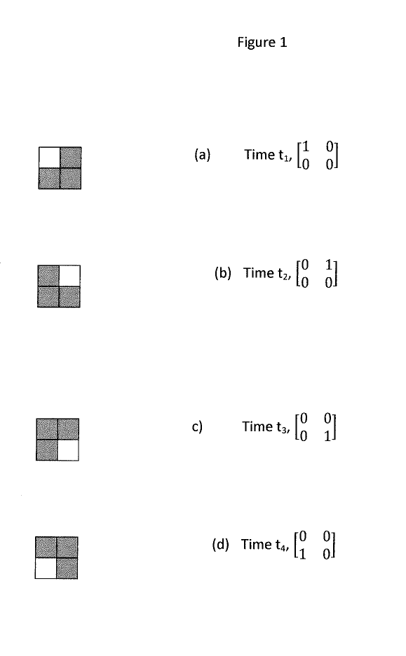

A switching architecture can be used, for example, by the following algorithm. A group of pixels 2×2 is arranged into square geometry as shown in FIG. 1. If one of the pixels is switched on, then it has value 1 multiplied by the value of color, other pixels have value 0 (null). So, there is a matrix:

$$( \begin{matrix}a & b \\ c & d\end{matrix} )$$

where elements a,b,c and d represent values of colors, for example, blue, red, green and orange. The values of colors come from the image. The values a,b,c and d are multiplied by 1 or 0. The 1 means that the pixel is switched on, 0 means that the pixel is switched off. Then the matrix has the following values:

$$( \begin{matrix}a & b \\ c & d\end{matrix} ) ( \begin{matrix}1 & 0 \\ 0 & 0\end{matrix} ) = ( \begin{matrix}a & 0 \\ 0 & 0\end{matrix} ) at time {t}_{0} ( \begin{matrix}a & b \\ c & d\end{matrix} ) ( \begin{matrix}0 & 1 \\ 0 & 0\end{matrix} ) = ( \begin{matrix}0 & b \\ 0 & 0\end{matrix} ) at time {t}_{0} + {Δ}_{t} , \\ ( \begin{matrix}a & b \\ c & d\end{matrix} ) ( \begin{matrix}0 & 0 \\ 1 & 0\end{matrix} ) = ( \begin{matrix}0 & 0 \\ c & 0\end{matrix} ) at time {t}_{0} + 2 Δ t , ( \begin{matrix}a & b \\ c & d\end{matrix} ) ( \begin{matrix}0 & 0 \\ 0 & 1\end{matrix} ) = ( \begin{matrix}0 & 0 \\ 0 & d\end{matrix} ) at time {t}_{0} + 3 Δ t , \\ ( \begin{matrix}a & b \\ c & d\end{matrix} ) ( \begin{matrix}1 & 0 \\ 0 & 0\end{matrix} ) = ( \begin{matrix}a & 0 \\ 0 & 0\end{matrix} ) at time {t}_{0} + 4 Δ t$$

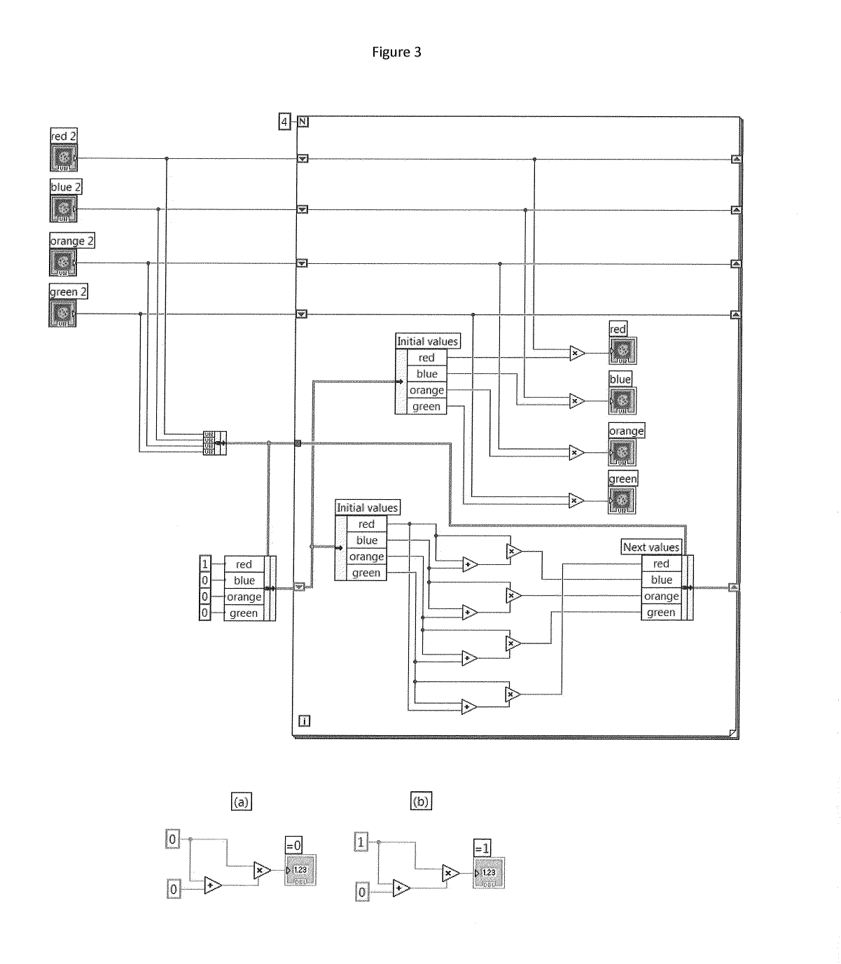

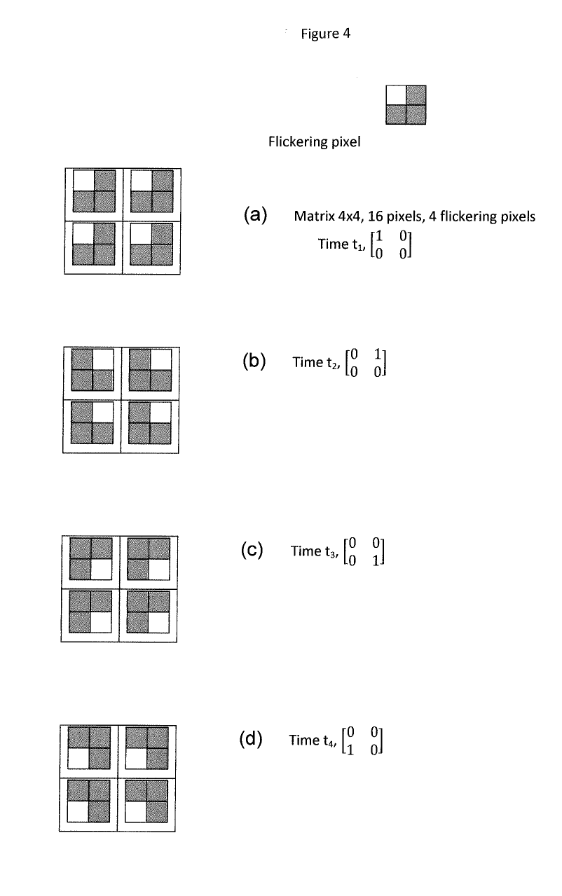

and so on. Here, t₀ is the starting time, At is the time period between two switching moments. After four switches the matrix returns to its initial value. If Δt is small enough the observer can integrate four pixels in the visual memory. The switching algorithm for this configuration is shown in FIG. 3. The frame shows operations within the time Δt, i.e. from time t₀ to t₀+Δt. Each pixel (blue, red, green and orange for simplicity) is shown separately and has a corresponding value of its color. Another matrix comprises 1 and zeros and have the values:

$$( \begin{matrix}1 & 0 \\ 0 & 0\end{matrix} ) , ( \begin{matrix}0 & 1 \\ 0 & 0\end{matrix} ) , ( \begin{matrix}0 & 0 \\ 1 & 0\end{matrix} ) and ( \begin{matrix}0 & 0 \\ 0 & 1\end{matrix} ) .$$

The individual pixels of the pixels group can be switched on one after another using clockwise switching sequence or a specially determined sequence different than clockwise. The human's visual memory helps to integrate images. Also external devices can be used to enhance the visual memory. The flickering pixels can be arranged so that colors of the simultaneously switching sub-pixels are of the same color group, for example, red group or blue group. The flickering pixels can be arranged so that colors of the simultaneously switching sub-pixels are of different color groups, for example, one sub-pixel belongs to red group, another to blue group. The flickering pixels can also be arranged so that colors of the simultaneously switching sub-pixels are chosen randomly.

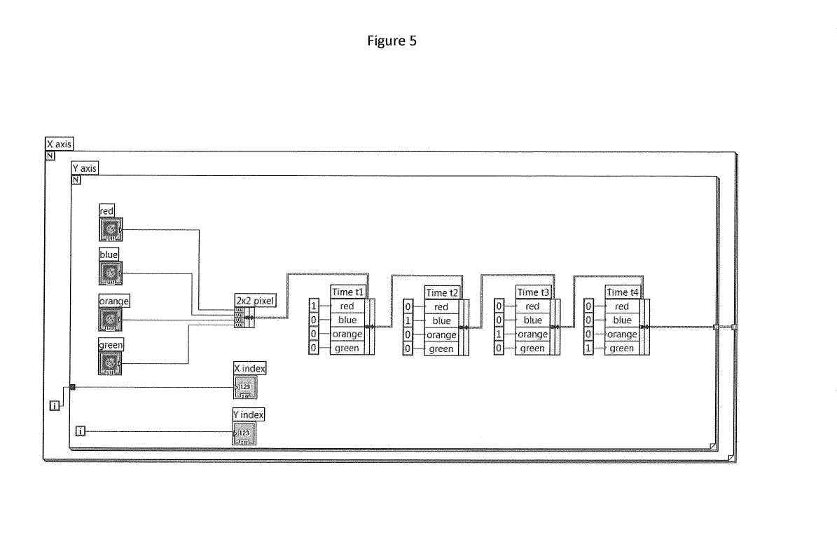

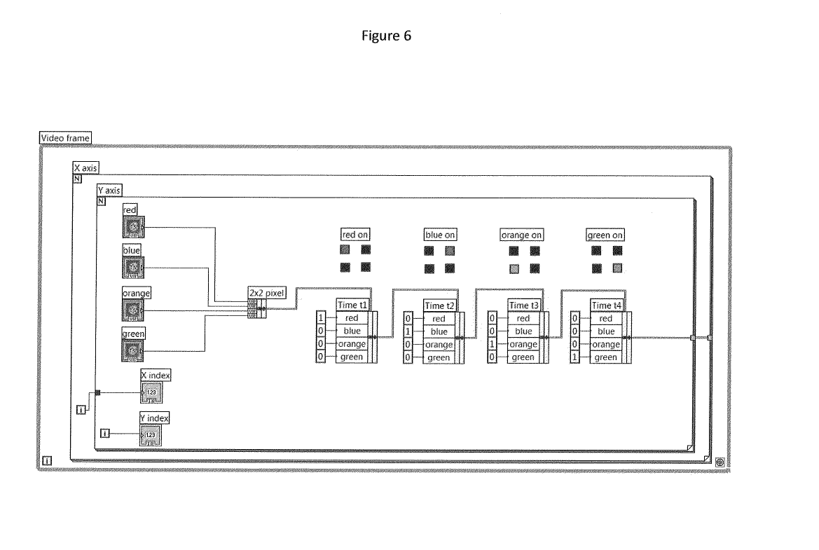

FIG. 3 is a diagram showing the control of switching for a group of pixels (red, blue, green, orange) for the program architecture. FIG. 5 shows the sequence discussed above, where one changes from red to blue to orange to green, while the others are zero. FIG. 6 shows the same arrangement for a video frame. The switching control can occur across the entire image or a portion thereof at a time.

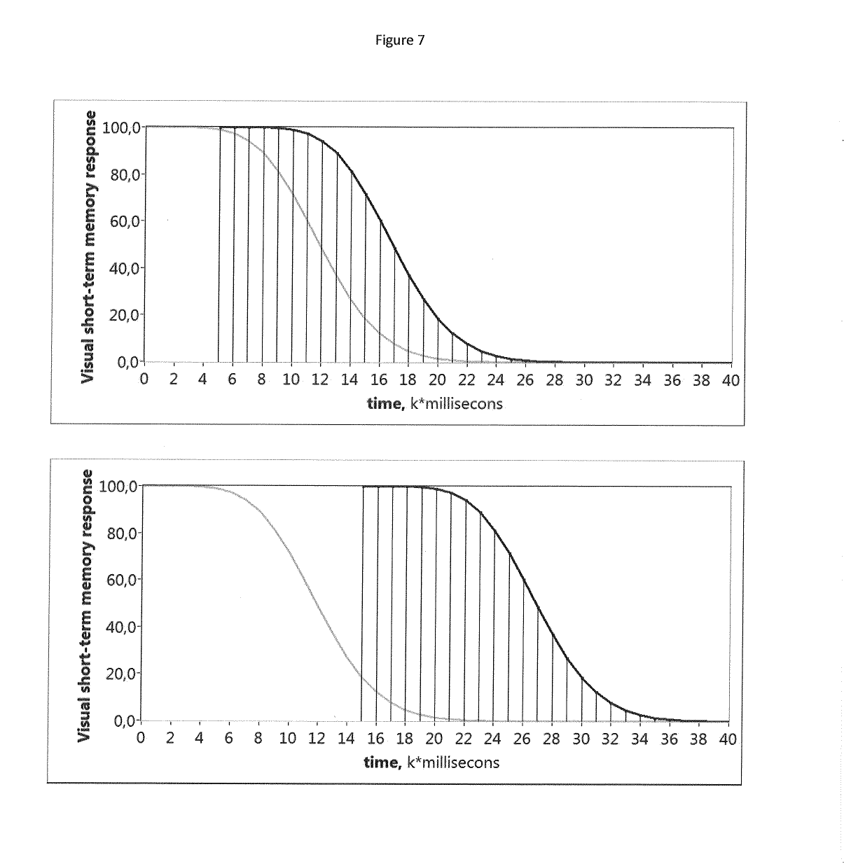

FIG. 7 shows how human short-term memory can be for the invention. Here, the term short-term memory is used in a broad sense to describe the principle. To be more precise, this is the sensory memory, the shortest memory. Similar algorithms can be also applied to represent stereo sounds. Here instead of color, a matrix of sound signals can be used.

Although a preferred embodiment of the invention has been disclosed for purposes of illustration, it should be understood that various changes, modifications and substitutions may be incorporated in the embodiment without departing from the spirit of the invention, which is defined by the claims which follow.

What is claimed is:

1. A system for displaying images, comprising:
a processor for dividing an image into a series of pixels or other visual elements and for grouping a selected number of said pixels or other visual elements into a pixel group; and
a circuit for providing power to individual pixels in the pixel group in succession at a selected switching rate, the switching rate being fast enough that an observer effectively sees all pixels or other visual elements in the pixel group being energized at the same time.

2. The system of claim 1, wherein the pixel group comprises four or more pixels.

3. The system of claim 1, wherein the switching time is within the range of 2-10 milliseconds.

4. The system of claim 1, wherein the pixel group comprises pixels of the same color.

5. The system of claim 4, wherein the color comprises one of the following: red, blue, orange, green.

6. The system of claim 1, wherein all of the pixel groups in a single image are processed at the same time.
